(19) United States
(12) Patent Application Publication
(10) Pub. No.: US 2011/0024019 A1
(43) Pub. Date: Feb. 3, 2011

(54) DECORATIVE TRANSFER METHOD AND APPARATUS

(75) Inventors: Scott M. Azzarello, Garfield Heights, OH (US); Timothy B. McGlinchy, Twinsburg, OH (US); James B. Williams, II, Seville, OH (US)

Correspondence Address: TAROLLI, SUNDHEIM, COVELL & TUMMINO L.L.P., 1300 EAST NINTH STREET, SUITE 1700, CLEVELAND, OH, 44114, US

(73) Assignee: GED Integrated Solutions, Inc., Twinsburg, OH (US)

(21) Appl. No.: 12/844,881

(22) Filed: Jul. 28, 2010

Related U.S. Application Data
(60) Provisional application No. 61/230,164, filed on Jul. 31, 2009.

(51) Int. Cl. B32B 37/12

(52) U.S. Cl. 156/60; 156/583.5

(57) ABSTRACT

A method and apparatus (50, 300) are provided for applying decorative material (52) to a component (C) comprising a first roller (70) having a heating element (72) substantially located centrally within the first roller (70). The apparatus (50, 300) further comprises a second roller (80) having a central hub (90) surrounded by an outer surface (92). The outer surface (92) is in contact with the first roller (70). The first roller (70) heats the outer surface (92) of the second roller (80) to a prescribed temperature. At least one idler roller (86) is located opposite the second roller (80) at an application region with at least a section of the component (C) passing therebetween. The second roller (80) applies heat and pressure to a decorative material (52) at the application region, forming a bonding connection between a decorative material (52) and component (C).

### CROSS REFERENCE TO RELATED APPLICATIONS

The present application claims priority to currently pending U.S. Provisional Application Ser. No. 61/230,164 that was filed on Jul. 31, 2009 entitled DECORATIVE TRANSFER METHOD AND APPARATUS. The above-identified application from which priority is claimed is also incorporated herein by reference in its entirety for all purposes.

### TECHNICAL FIELD

The present disclosure relates to a decorative transfer method and apparatus for applying material to windows, doors, or their components that enhance and/or change the appearance and increases the window's or door's overall aesthetic appeal.

### BACKGROUND

Illustrated in FIGS. 1-3 are front, side, and top views of an insulating glass unit “IGU” 10 resembling a conventional double-hung window sash assembly having upper and lower spacer frame assemblies 12, 14, respectively. Rails 16, 18, 20, and 22 form the horizontal portions of the upper and lower spacer frames, 12, 14, while stiles 24, 26, 28, and 30 form vertical supports between the rails. The IGU 10 resembles a typical conventional window that includes muntins 32, which divide individual or simulated panes of glass 34 (also known as lights).

In modern windows, muntins 32 are either sandwiched between double glass panes forming the entire window or are separate pieces affixed to both the interior direction of arrow “I” (as viewed from the inside of the home or building) and exterior direction of arrow “E”(as viewed from the outside of the home or building) portions of the IGU 10 to preserve the traditional colonial appearance, as shown in FIG. 2. Muntins are typically made from formed rolled metal. Further discussion relating to the assembly and construction of the muntins within the spacer frame assembly is found in U.S. Pat. No. 6,687,982 entitled LAMINATED MUNTIN BAR METHOD, which is assigned to the assignee of the present disclosure and incorporated herein in its entirety by reference.

A channel assembly 40 comprising left 42 and right 44 channel tracks support upper and lower spacer frames 12, 14 as illustrated in the plan view of FIG. 3. Both the left 42 and right 44 channel tracks comprise an exterior flange 42E and 44E, a middle flange 42M and 44M, and an interior flange 421 and 441, all supported by a support member 42S, 44S that extend about the overall height of the IGU 10 illustrated by dimension “h” in FIG. 2. The channel 40 and tracks 42 and 44 support the travel of the upper and lower spacer frames 12, 14 during the opening and closing of the frames, indicated by the arrows A in the side view of FIG. 2.

Arrows “I” in FIGS. 1-3 extend in a direction from the window toward the inside of a home or building. Arrows “E” in FIGS. 1-3 extend in a direction from the window toward the outside of a home or building. The stiles, muntins, and rails as viewed from the interior of the home or building are typically and desirably made from wood or a simulated wood grain, while the overall construction is a composite having a base material of metal or extruded vinyl. In contrast, the outside of the IGU 10 is typically formed from white colored vinyl, although other colors and materials are also used.

The spacer frames 12, 14 and channel assembly 40 in modern windows are typically constructed as a complete unit an inserted into a rough opening located in a home or building for both new and old construction. As illustrated in FIG. 3, the channel assembly 40 is typically secured within the building or home walls “W” or behind trim, concealing both the interior and exterior flanges.

### SUMMARY

One example embodiment of the present disclosure includes an apparatus for applying decorative material to a component. The apparatus comprises a workstation defining a passageway for movement of a component along a first direction through the passageway in the workstation. The apparatus further comprises a first roller having a first outer diameter and a heating element positioned within the first outer diameter. The apparatus also includes a second roller having a second outer diameter in rotational contact with the first outer diameter of the first roller. The first roller provides heat to the second outer diameter of the second roller. The second roller further applies heat and pressure along a second direction to a decorative material and a surface of a component. The heat and pressure applied by the second roller bonds the decorative material to a surface of the component along the second direction, wherein the second direction is transverse to the first direction.

A further example embodiment of the present disclosure includes an apparatus for applying decorative material to a component comprising a first roller having a heating element substantially located centrally within the first roller. The apparatus further comprises a second roller having a central hub surrounded by an outer surface. The outer surface is in contact with the first roller. The first roller heats the outer surface of the second roller to a prescribed temperature. The apparatus also comprises a plurality of idler rollers in contact with a component as it is advanced through the apparatus. At least one of the idler rollers is located opposite the second roller at an application region with at least a section of the component passing therebetween. The second roller applies heat and pressure to a decorative material at the application region, forming a bonding connection between a decorative material and component.

Another example embodiment of the present disclosure includes a method for applying decorative material to components comprising the steps of fixing a heat roller and a pressure roller in rotational contact in a decorative applicator. The method further comprises heating the surface of the pressure roller with the rotational contact of the heat roller and pressure roller and driving a component through the decorative applicator with the rotational movement of the pressure roller. The method also includes applying heat and pressure to the component and a decorative material with the pressure roller to form an adhesive bond between at least a portion of the decorative material and component.

### BRIEF DESCRIPTION OF THE DRAWINGS

The foregoing and other features and advantages of the present disclosure will become apparent to one skilled in the art to which the present disclosure relates upon consideration of the following description of the invention with reference to the accompanying drawings, wherein like reference numerals, unless otherwise described refer to like parts throughout the drawings and in which:

FIG. 1 is a front view of a double hung window assembly;

FIG. 2 is a perspective view of the double hung window assembly of FIG. 1 supported by a track assembly;

FIG. 3 is a plan view of the double hung window assembly of FIG. 1 supported by the track assembly;

FIG. 4A is a sectional perspective view of double hung window assembly in a closed position supported by a channel assembly, the channel assembly having a middle flange with a laminating foil that was applied to its surface in accordance with one example embodiment of the present disclosure;

FIG. 4B is a sectional perspective view of double hung window assembly in an opened position supported by a channel assembly, the channel assembly having a middle flange with a laminating foil that was applied to its surface in accordance with one example embodiment of the present disclosure;

FIG. 4C is a plan view of the double hung window assembly of FIGS. 4A and 4B supported by the channel assembly, the channel assembly having a middle flange with interior and exterior sides with a laminating foil that was applied to both sides in accordance with another example embodiment of the present disclosure;

FIG. 4D is a partial perspective view of a door assembly, the door assembly having a middle flange with interior and exterior sides with a laminating foil that was applied to the middle flange in accordance with another example embodiment of the present disclosure;

FIG. 5 is a right side perspective view of an applicator assembly constructed in accordance with one example embodiment of the present disclosure;

FIG. 6 is a plan view of a laminating foil constructed in accordance with one example embodiment of the present disclosure as it approaches a desired portion of a component to form an adhesive bond;

FIG. 7 illustrates a magnified exploded perspective view of a portion of an applicator assembly constructed in accordance with one example embodiment of the present disclosure;

FIG. 8 illustrates a top view of a magnified portion of an applicator assembly constructed in accordance with one example embodiment of the present disclosure;

FIG. 9 is a left side perspective view of an applicator assembly constructed in accordance with one example embodiment of the present disclosure;

FIG. 10 is a right side view of an applicator assembly constructed in accordance with one example embodiment of the present disclosure;

FIG. 11 is a front elevation view of an applicator assembly constructed in accordance with one example embodiment of the present disclosure;

FIG. 12 is a rear elevation view of an applicator assembly constructed in accordance with one example embodiment of the present disclosure;

FIG. 13 is a top view of an applicator assembly constructed in accordance with one example embodiment of the present disclosure;

FIG. 14 is a flowchart of a method for applying material to components in accordance with one example embodiment of the present disclosure;

FIG. 15 illustrates a magnified exploded perspective view of a portion of an applicator assembly constructed in accordance with one example embodiment of the present disclosure;

FIG. 16 illustrates a top view of a magnified portion of an applicator assembly constructed in accordance with one example embodiment of the present disclosure;

FIG. 17 illustrates a left side perspective view of an applicator assembly constructed in accordance with one example embodiment of the present disclosure;

FIG. 18 illustrates a right side perspective view of the applicator assembly illustrated in FIG. 17;

FIG. 19 illustrates a magnified perspective end view of the applicator assembly of FIG. 17;

FIG. 20 illustrates an overhead perspective view of the applicator assembly of FIG. 17;

FIG. 21 is a top view of the applicator assembly of FIG. 17;

FIG. 22 is a front view of the applicator assembly of FIG. 17;

FIG. 23 is a right side elevation view of the applicator assembly of FIG. 17;

FIG. 24 is a left side elevation view of the applicator assembly of FIG. 17; and

FIG. 25 is a magnified end view of the applicator assembly of FIG. 24.

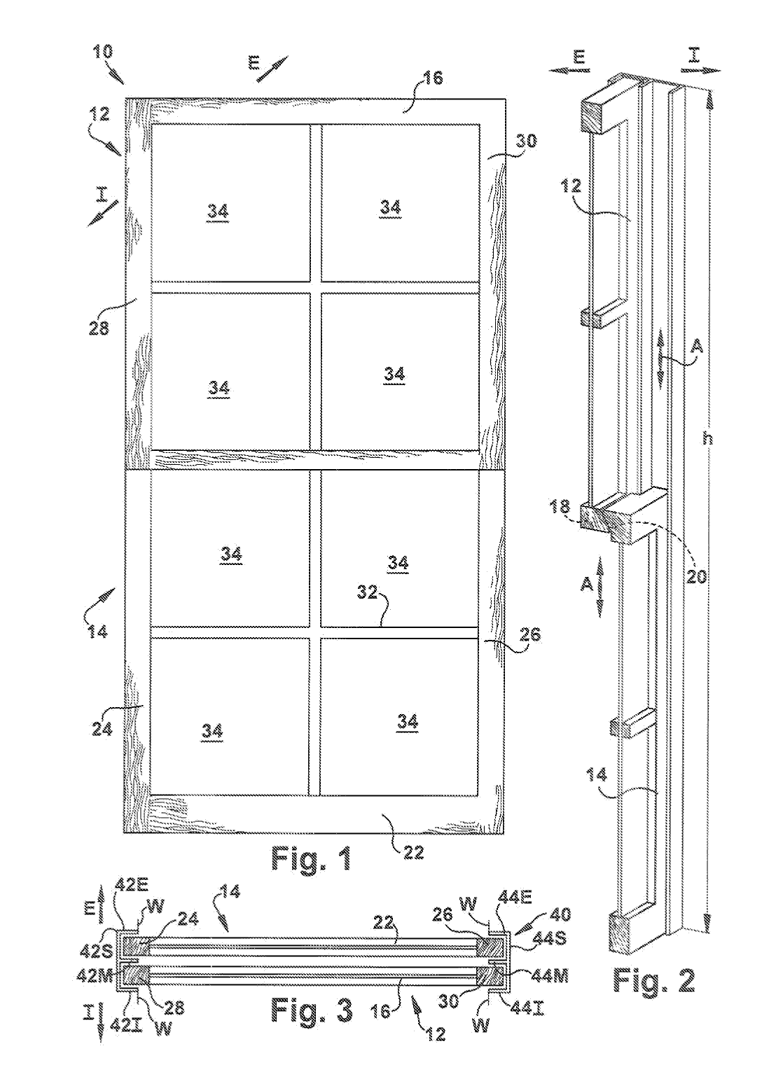

### DETAILED DESCRIPTION

The present disclosure relates to a decorative transfer method and apparatus for applying material to windows or doors or their components that enhance and/or change the appearance and increases the window's or door's overall aesthetic appeal. More specifically, the present disclosure employs an apparatus that bonds the material to the window or door or their components by using a combination of both heat and pressure.

The method and apparatus used to apply a decorative covering material described in the present disclosure, advantageously eliminates any surface preparation with cleaners or solvents and instantly cures with the desired window or door surface or on a component's surface that is used in a window or door. In comparison, conventional materials require days for curing in climate controlled environments, adding time, inventory, and cost to the window or door assemblies. Further, such conventional techniques typically use environmentally hazardous cleaning and application materials not required in the present disclosure.

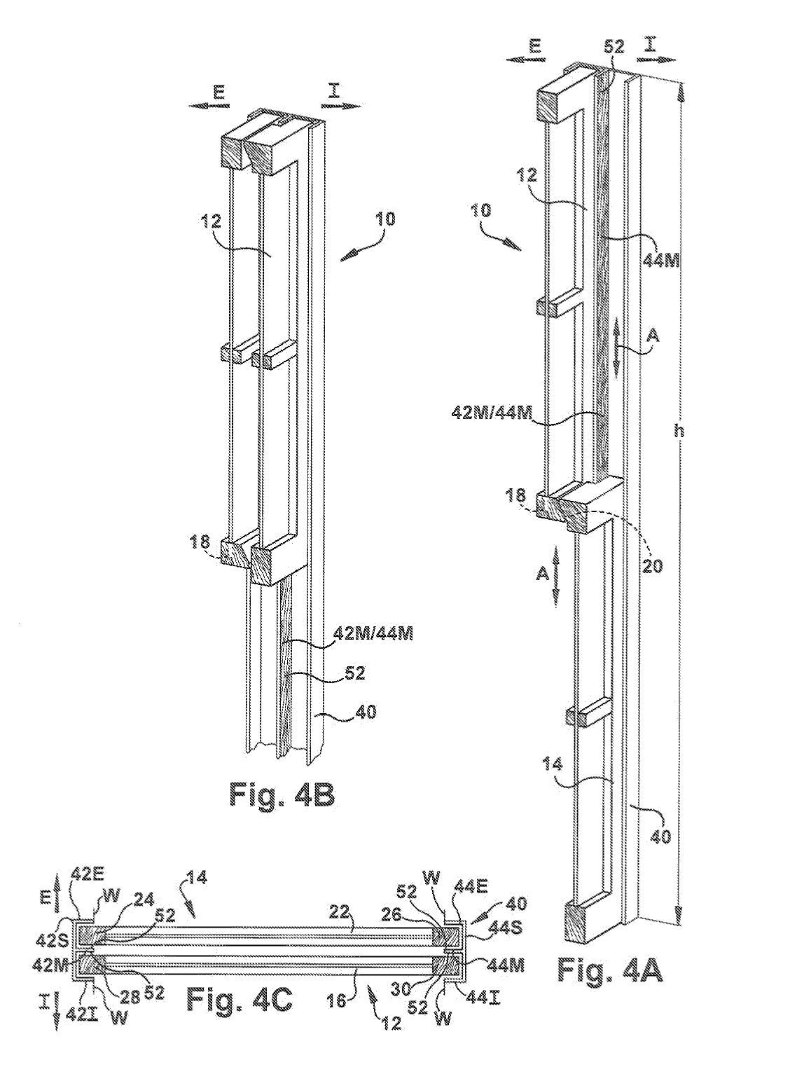

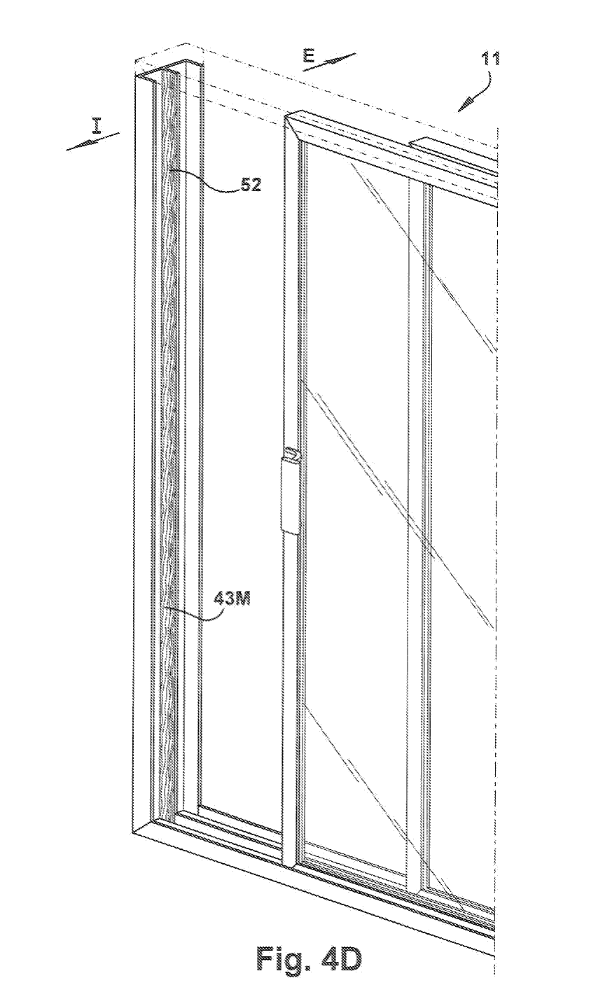

Referring now to the figures and in particular FIGS. 4A, 4B, and 4C are various views of a double hung window assembly in the form of an IGU 10 supported by a channel assembly 40 having a middle or center flange 42M/44M with interior I and exterior E sides. The channel assembly 40 acts as a component “C” part of the frame forming the window or IGU 10. The sides of middle flange 42M/44M include a covering material 52 in the form of a laminating foil 54 that was applied to both sides through separate passes by one or more applicator assemblies constructed in accordance with one or more example embodiments of present disclosure.

Alternatively, FIG. 4D illustrates a partial perspective view of a door assembly 11. The door assembly 11 includes a middle flange 43M forming two channels or tracks in the door frame that forms one component “C” of the door assembly. The middle flange 43M has interior “I” and exterior “E” sides noted by the respective arrows. The middle flange 43M includes a covering material 52 in the form of a laminating foil 54 that was applied to both sides through separate passes by one or more applicator assemblies constructed in accordance with one or more example embodiments of present disclosure.

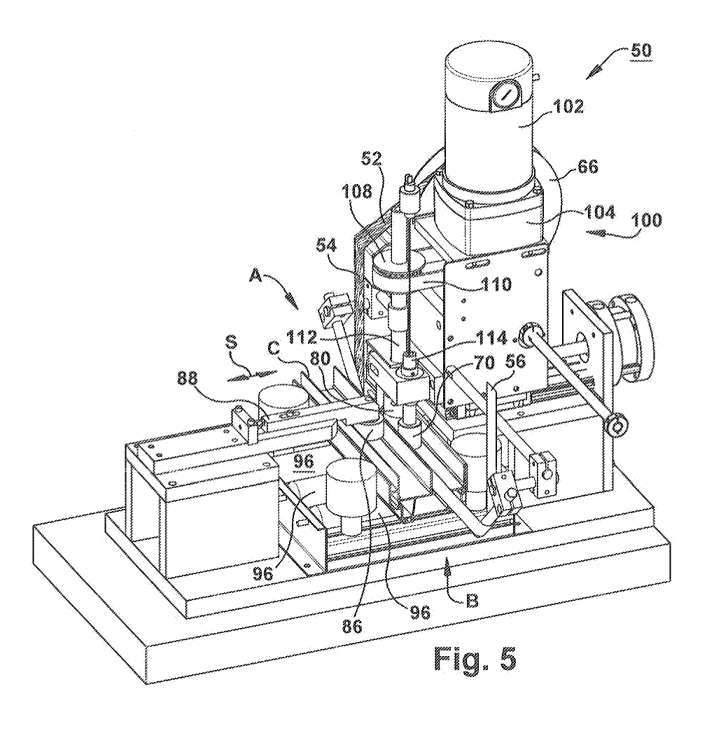

FIG. 5 illustrates a perspective view of an applicator assembly 50 constructed in accordance with one embodiment of the present disclosure. The applicator assembly 50 is shown applying a covering material 52 to a single surface of a window or a door component “C” as it passes through an entrance side “A” to an exit side “B” of the applicator.

In the illustrated example embodiment, the window or door component C is made from vinyl and includes a center or middle channel/track used to support a window sash or door assembly shown in FIGS. 4A-4D. However, the component C, as now defined and used throughout both the specification and claims, also includes any size or shape window, door, or part forming the window, door, or supporting track assembly, including but not limited to, stiles, rails, tracks, frames, jambs, headers, sills, and channels on both interior and exterior sides of the window or door without departing from the spirit and scope of the claimed disclosure. In addition, the material composition forming the component C is not limited to vinyl, but could be any type of material, including without limitation, metal, plastic, fiberglass, polymeric composition, or naturally existing material. Further the surface of the component C could be cleaned or treated, for example with a sealant or painted prior to use by an applicator assembly constructed in any of the example embodiments of the present disclosure. It is within the spirit of the present claimed disclosure that the numerous uses of the term “component”, “component C”, or “C” whether in singular or plural form throughout the various example embodiments of applicator assemblies herein embrace the full scope of the aforementioned definition as well as any subsequent definitions.

The applicator assembly 50 can apply the covering material to any component C without regard to the component's stock length that can be several meters, while only a small portion is shown in the illustrated embodiment. The covering material 52 in the example embodiment is applied to the desired portion P of the component through the combination of heat and pressure applied by the applicator assembly 50. The applicator assembly 50 may also be used to apply the decorative covering material 52 to a door 11 or a window sash 10 that may include an insulating glass unit. In FIGS. 4A-4D, the decorative covering material 52 has been adhered automatically by the applicator 50 uniquely to one side of the middle flange 42M/44M of the channel 40 or 43M of the door 11. Such an application was unachievable with conventional equipment. By applying a wood simulated covering material 52 to one side of the middle flange 42M, 44M, and 43M as best seen in FIGS. 4A-4D, when looking from the inside the building or home outward, the covering material on the middle flange blends nicely with the wood or wood appearance on the window and door and exposed portions of the window or door frame and trim molding. In contrast, the opposite side of the middle flange as seen from the outside the home or building remains white or a decorative adhesive of a prescribed color in the covering material 52 is similarly applied to the component C such that the exterior and side of the middle flange conveniently match with the exterior color of the window or door assemblies.

In an alternative example embodiment, the decorative covering material 52 is not limited to a simulated wood pattern but is a solid color or custom pattern selected by the home owner or manufacturer of doors and windows. For example, the decorative covering material 52 could be a solid color or brick pattern on the surfaces of the components C or channel assembly 40 visible from the outdoors to match the exterior of the home or building in which the window or door is installed. In the same example embodiment, the decorative material 52 applied to the components C or channel assembly 40 could be a pattern or color to match the décor visible from the interior of the home or building in which the window or door is installed

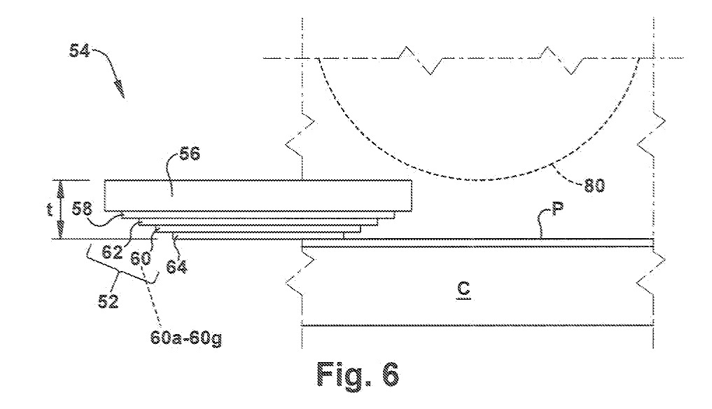

In the illustrated example embodiment, the covering material 52 is part of an elongated strip or laminating foil 54, as depicted in FIG. 6. The second elongated strip 54, sometimes referred to as a hot stamp lamination foil, comprises a carrier layer 56, typically a polyester film, which provides a backing or substrate for the strip 54. A release layer 58 is adhered to the carrier layer 56 and, in turn, the covering material 52 is adhered to the release layer 58. The release layer 58 preferably is a lacquered resin with a low melting point. During the lamination or application process, when the strip 54 is sufficiently heated, the release layer 58 melts, thereby releasing or separating the covering material 52 from the carrier layer 56. Pressure in combination with the heat causes the covering material 52 to be thermally bonded to the desired portion P of the component C. The construction of the covering material 52 is best seen in FIG. 6 as it approaches the desired portion P of a component C.

In the illustrated example embodiment of FIG. 6, the covering material 52 comprises three separate layers, namely a decorative color or printed layer 60, a protective layer 62, and an adhesive layer 64. The decorative color or printed layer 60 can include a number or individual layers e.g. 60a-60g, having different shades, patterns, or variety of ink and/or colors.

The protective layer 62 protects the decorative color layer 60 from scratching, chemical attack, and UV (ultra violet) fading. The overall dimensional stack-up (represented by dimension “t”) of the strip 54 in the illustrated embodiment is approximately 0.0019″ inches in thickness and the carrier layer 56 is approximately 0.0014″ inches in thickness. The applicator assemblies 50 and 300 discussed below, however are constructed to adjust for strips 54 and the components C of varying thicknesses up to several inches without departing from the spirit and scope of this disclosure.

The decorative color layer 60 may be a desired paint color or a printed image, e.g., a wood grain finish appearance. A decorative color layer 60 is typically an ink lacquer that dries very rapidly by release of a solvent. After application of the covering material 52 to the desired portion P of the component C, the protective layer 62 functions as an outer protective surface for the decorative color layer 60 to protect the color layer from scratching, chemical exposure, and UV radiation exposure.

The third component of the covering material 52 of the laminating foil strip 54 is the adhesive layer 64. The adhesive layer 64 comprises an adhesive that is formulated for compatibility the surface of the desired portion P of the component C, as well as the decorative color layer 60. The surface of the desired portion P in the illustrated embodiment of FIG. 5 is a vinyl surface, but could equally be a metal, fiberglass, natural material and/or painted surface without departing from the spirit and scope of the claimed disclosure. The adhesive layer 64 is typically comprised of a combination of resins (lacquers) that cure from applied heat and the chemically adhering or bonding of the decorative color layer 60 to the surface of the desired portion P of the component C. Additionally, the adhesive layer 64 adheres to the component C and is sufficiently elastic to resist delamination of the covering material 52, including at the ends of the component C.

In yet another alternative example embodiment, the decorative material 52 is a hot stamp foil product designed to thermally bond to the surfaces of components C manufactured by CPS Resources of Indian Trail, N.C. 28079. Such decorative material 52 whether the example embodiment of FIG. 6 or that sold by CPS Resources, equally thermally bond the decorative material 52 to the component C when used in connection with any of example embodiment applicator assemblies of the present disclosure.

Returning again to FIG. 5, the covering material 52 that includes the carrier layer 56 to form the laminating foil 54 is provided to the applicator assembly 50 from a supply reel 66 located on the entrance side A of the applicator. Once the covering material 52 is applied and adhered to the desired portion P of the component C, the carrier layer 56 separates from the laminating foil as a continuous strip as it departs from the exit side B of the applicator 50 as shown in FIG. 5 onto a take-up reel (not shown). In the illustrated example embodiment, the desired portion P is the interior I and exterior E sides of the middle flange 42M/44M/43M of FIGS. 4A-4D.

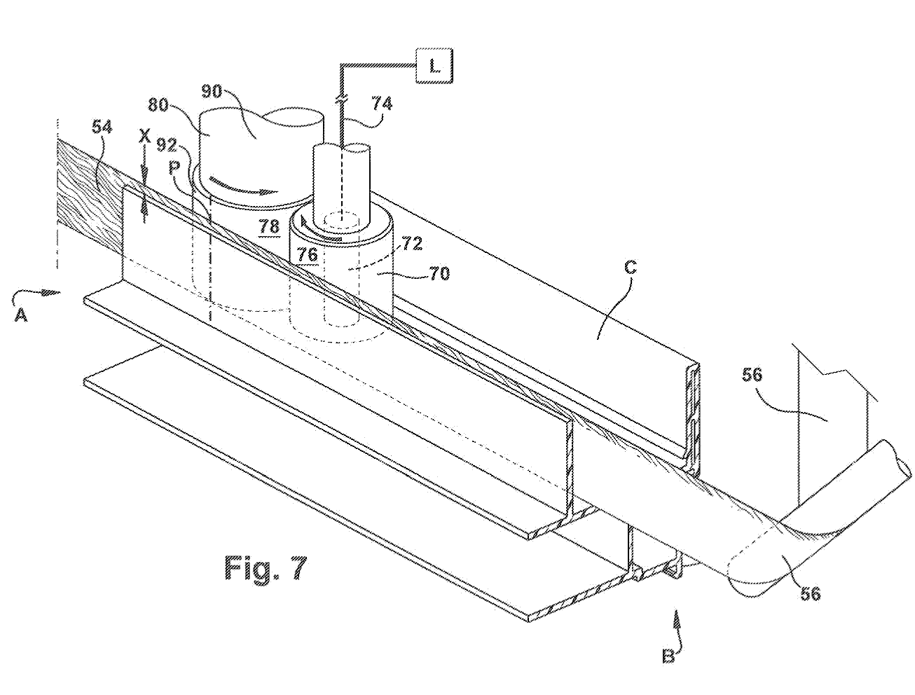

FIG. 7 illustrates a magnified exploded perspective view of a portion of the applicator 50 comprising a heat roller 70 having an internal heating element 72. The heating element 72 receives regulated energy from a power source feed 74 attached to a controller L. The controller L can be any computer system, such as a central processing unit, personal computer, programmable logic controller (“PLC”), and the like for monitoring input data and accordingly, adjusting output data as can be appreciated by one skilled in the art.

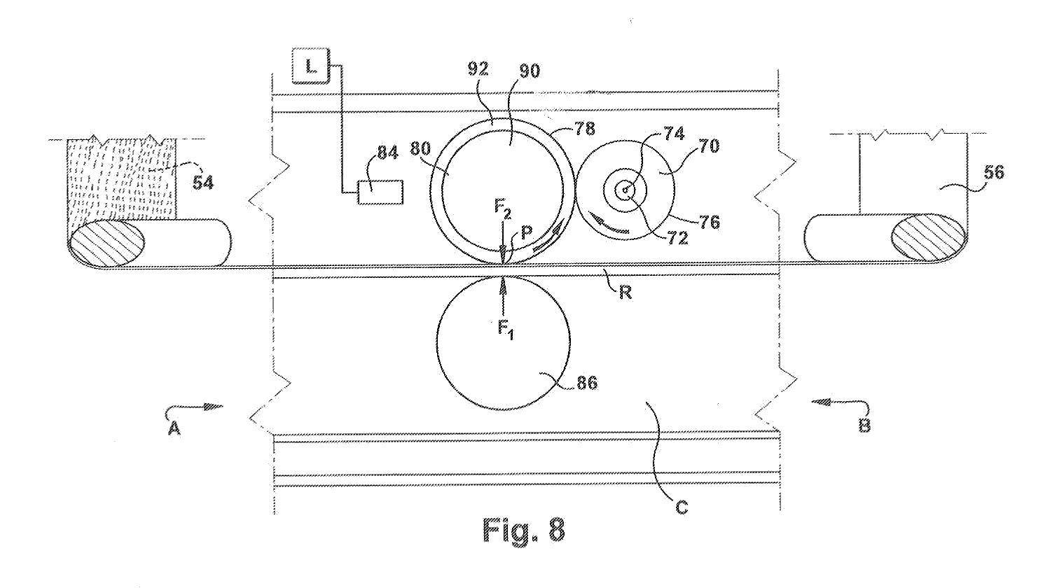

The heating element 72 rotates with the heat roller 70 (as indicated by the arrows in FIGS. 7 and 8) and provides uniform heat throughout the roller, including its external surface 76. The external surface 76 of the heat roller 70 is in physical contact with an external surface 78 of a pressure roller 80. The external surface 78 of the pressure roller 80 through the conductive heat transfer from the heat roller 70 and contacting surface 76 apply a controlled amount of heat in combination with pressure needed to attach the covering material 52 of the laminating foil 54 to the desired portion P of the component C.

In one example embodiment, the heating element 72 is a 200 Watt heat stick, ⅜″ inches in diameter and 1¼″ inches in length. A suitable example of the heating element 72 includes a heat stick manufactured by Watlow Electric Manufacturing Company of St. Louis, Mo. under part number #G1E95-L2. In the illustrated embodiment, the heating element elevates the surface 76 temperature of the heat roller 70 such that the conducted heat maintains a temperature range between 350 and 500 degrees Fahrenheit on the external surface 78 of the pressure roller 80. In the illustrated example embodiment, the pressure roller 80 outer surface as measured by heat sensor 82 is regulated by controller L at a temperature of approximately 450 degrees Fahrenheit.

In yet another example embodiment, the heat roller 70 is a constructed from 300 series stainless steel bored for receiving the heating element 72. The heating roller in the illustrated embodiment has a height of approximately two (2″) inches and a diameter of approximately three quarters of one inch (¾″) to fit between the channels of the component C, but could be larger or smaller to accommodate the window or door component size and area of application.

FIG. 8 illustrates a top view of a magnified portion of the applicator 50. As can be seen in FIG. 8, the heat roller 70 has a smaller diameter than the contacting pressure roller 80. Accordingly, the heat roller 70 does not contact the surface of component C, as the component moves past and through the applicator assembly 50. Heat sensor 84 measures the surface temperature of the pressure roller 80 and communicates the temperature to the controller “L” in a feedback control signal loop, allowing for the adjustment of the heating element 72 to a prescribed temperature or range of temperatures. Infrared sensors known by those skilled in the art are suitable examples for the heat sensor 84. Additional heat sensors (not shown) could be added for monitoring or safety around the perimeter of the heat roller 70.

Located opposite a riser portion R of the component C on which the covering material 52 is applied is an idler roller 86. The idler roller 86 applies a reactant force F1 against an applied force F2 generated by the pressure roller 80. The force required and applied by the pressure roller 80 will vary based on the profile of the component C. However, most applications will have a load setting up to approximately 1,800 pounds of force at the surface of the pressure roller 80. In the illustrated embodiment, the amount of applied force F2 by pressure roller 80 against the laminating foil 54, riser portion R and idler roller 86 at the desired portion P in one example embodiment is one hundred and five (105) pounds force. In the illustrated example, the pressure roller 80 contacts 0.12 (in²) square inches of the riser portion R, resulting in eight hundred seventy-five (875) pounds per square inch of pressure (“PSI”). The amount of pressure however can be altered for higher or lower levels through an adjustment slide 88 (see FIG. 5) that increases or decreases the distance (and resulting force) of the idler roller 86 from the pressure roller 80 the directions of the arrow S shown in FIG. 5.

In an exemplary embodiment, the pressure roller 80 comprises an aluminum hub 90 surrounded by a silicone annular outer surface 92 approximately a quarter of one inch in thickness (¼″) that is integral with and molded to the aluminum hub. In the illustrated example embodiment, the silicone outer surface 92 has a relative softness ranging between 50 to 90 on a Shore A scale, a height of two (2″) inches, and a diameter of approximately one (1″) inch to fit between the channels formed by 42M/44M/43M of the component C, but could be larger or smaller to accommodate the channel component size and area of application. Using the heat roller 70 in contact with the silicone outer surface 92, reduces the amount of heat exposure on the inner diameter of the silicone outer surface, preventing an adhesive used to attach the silicone outer surface along its inner diameter to the aluminum hub 90 from breaking down or delaminating. The silicone outer surface 92 provides a pliable contact surface to the decorative material 52 and component C.

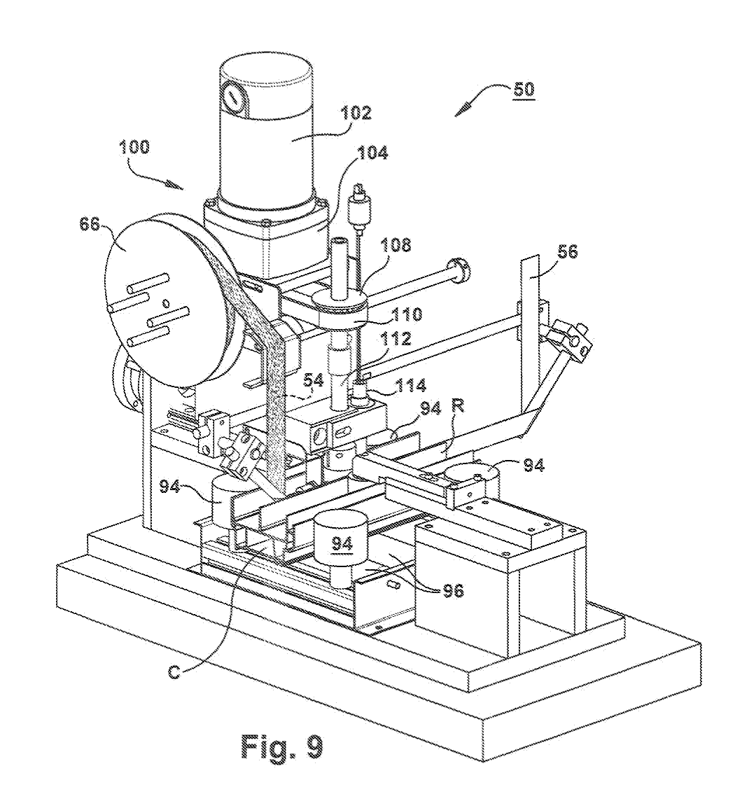

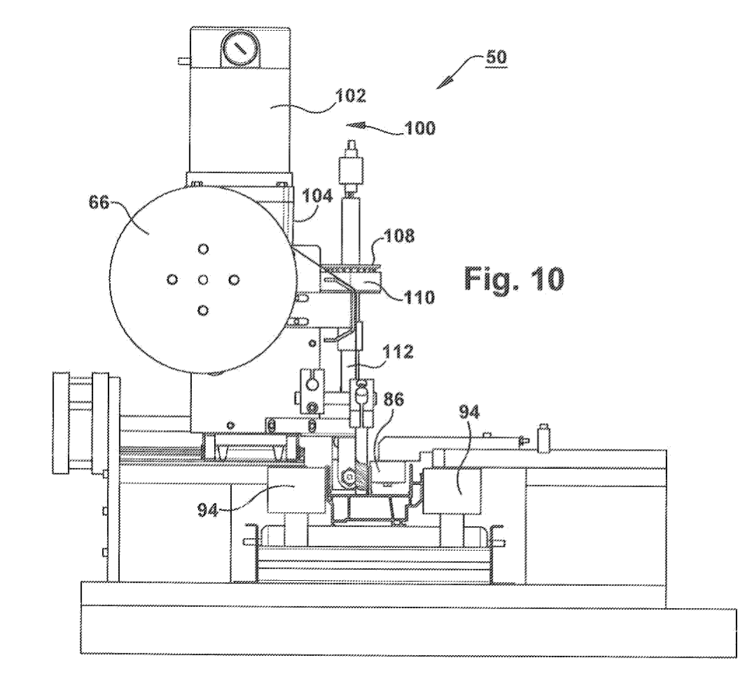

FIGS. 9-10 illustrate a right side perspective and end views of the applicator assembly 50 constructed in accordance with one embodiment of the present disclosure. FIGS. 5 and 9-10 illustrate the ancillary vertical rollers 94 that engage and support the component C as it passes through the applicator assembly 50. Additional support is provided to the component C as it passes through the applicator 50 by horizontal rollers 96 as seen in FIGS. 5 and 9. The vertical rollers 94 can be adjusted to accommodate any window or door component C through fixture adjustments as can be appreciated by those skilled in the art without departing from the spirit and scope of the claimed invention.

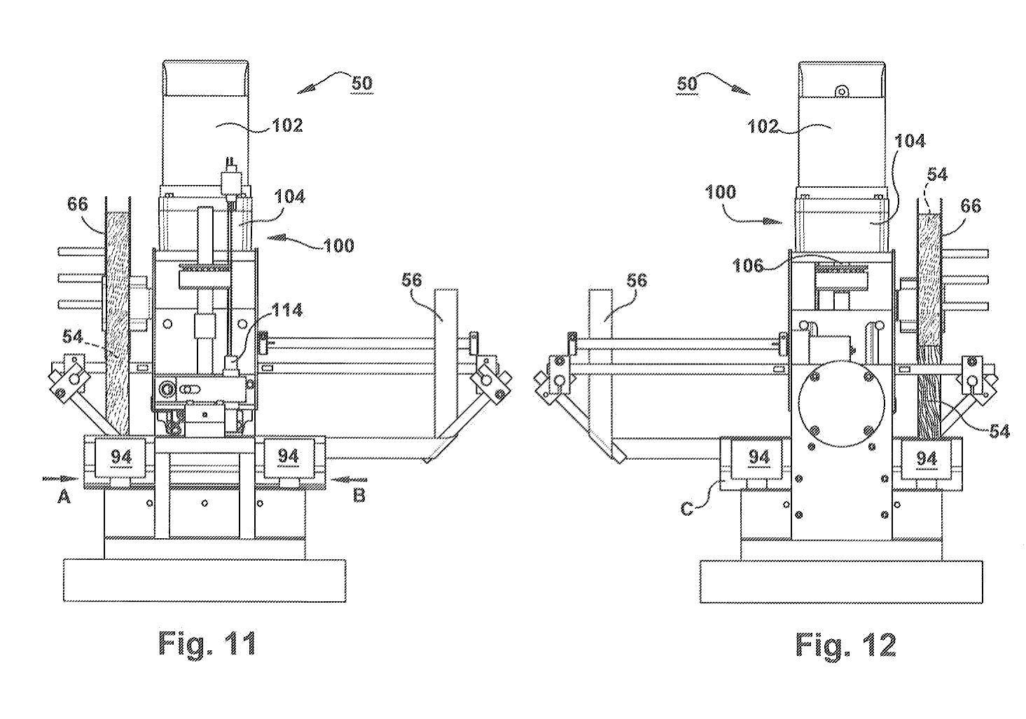

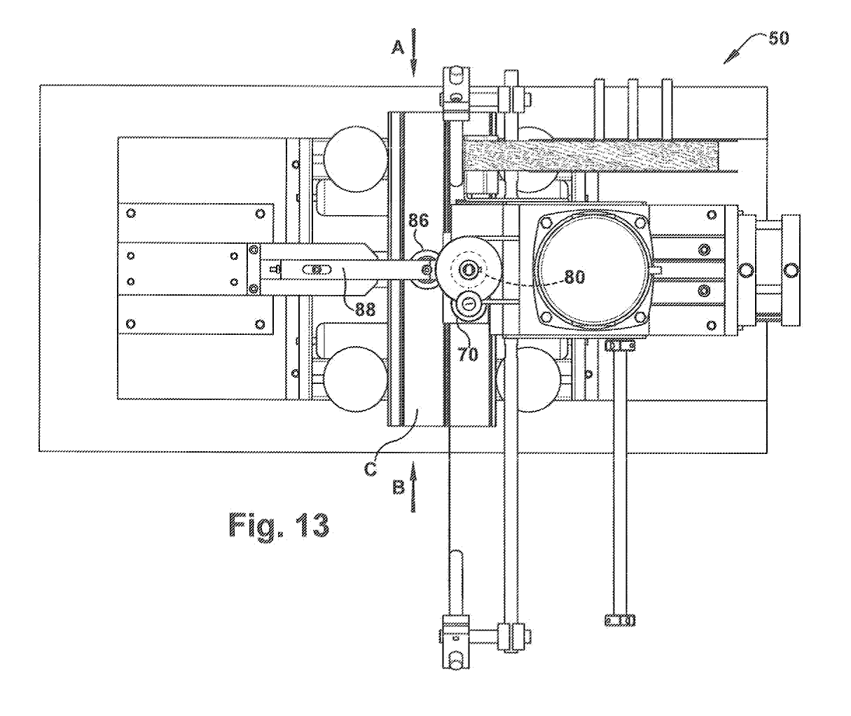

Referring now to FIGS. 11 and 12 are front and rear views, respectively of the applicator assembly 50 constructed in accordance with one embodiment of the present disclosure. The pressure roller 80 and heat roller 70 are rotated by a drive assembly 100, as best seen in FIGS. 5, 11 and 12. The drive assembly 100 comprises a motor 102 engaged to a gear box 104 that includes a pinion gear 106 coupled a drive gear 108 via a drive belt or drive chain 110 attached to a drive shaft 112 as shown in FIG. 10. The pressure roller 80 is coupled to, and rotated by the drive shaft 112. The contact of the pressure roller 80 with the heater roller 70 causes the rotation of the heater roller 70, as indicated by the arrows shown in FIGS. 7 and 8. The pressure roller 80 in addition to providing both heat and pressure to the component C, drives the component through the applicator assembly 50. Decorative material 52 has been successfully applied to components C passing through the applicator assembly 50 at a feed rate of approximately twenty feet per minute.

In one embodiment, the drive gear 108 is a uni-directional slip drive. The uni-directional slip drive allows a combination of multiple applicator assembly machines 50 to be placed in series for the simultaneous application of covering material 52 to different portions along the channels of the component C. The multiple applicator assemblies 50 in combination with a uni-direction slip drive 108 would allow the applicator machine with the fastest feed rate to control the movement of the component C through the applicator assemblies. This would avoid the need for synchronizing the applicator assemblies' 50 motor speeds. An example of a suitable uni-direction slip drive gear 108 can be purchased from McMaster-Carr website www.mcmaster.com, which is identified as one way locking needle bearing gear under McMaster-Carr part number #2489K5.

As the heater roller 70 rotates, the power source feed 74 to controller L advantageously remains stationary due to a rotational switch 114 illustrated in FIGS. 5 and 11. In one embodiment, the rotational switch is a mercury switch capable of handling the 200 W heating element 72. An example of a suitable rotational switch 114 includes a switch manufactured by Mercotac, Inc. Carlsbad, Calif. under part number #MER00230.

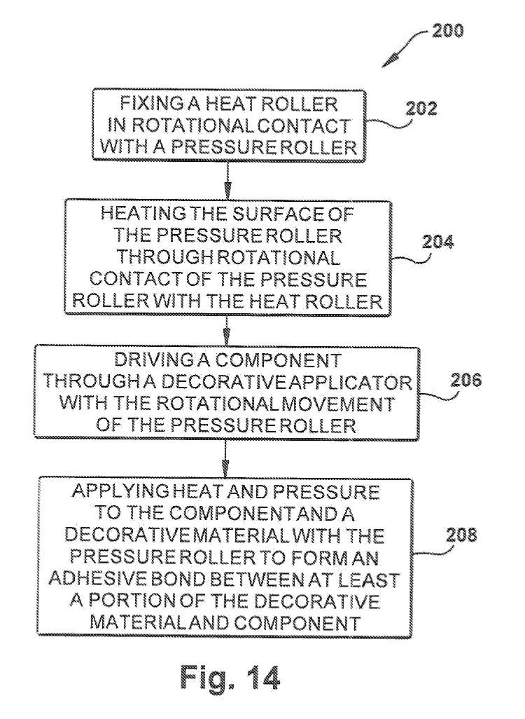

Illustrated in FIG. 14 is a flowchart summarizing a method 200 for applying decorative material to windows, doors, or their components in accordance with one embodiment of the present disclosure. At 202, the method 200 comprises fixing a heat roller and a pressure roller in rotational contact in a decorative applicator. At 204, the method 200 includes heating the surface of the pressure roller with the rotational contact of the heat roller against the pressure roller. At 206, the method 200 comprises driving a component through the decorative applicator with the rotational movement of the pressure roller. At 208, the method 200 comprises applying heat and pressure to the component and a decorative material with the pressure roller to form an adhesive bond between at least a portion of the decorative material and component.

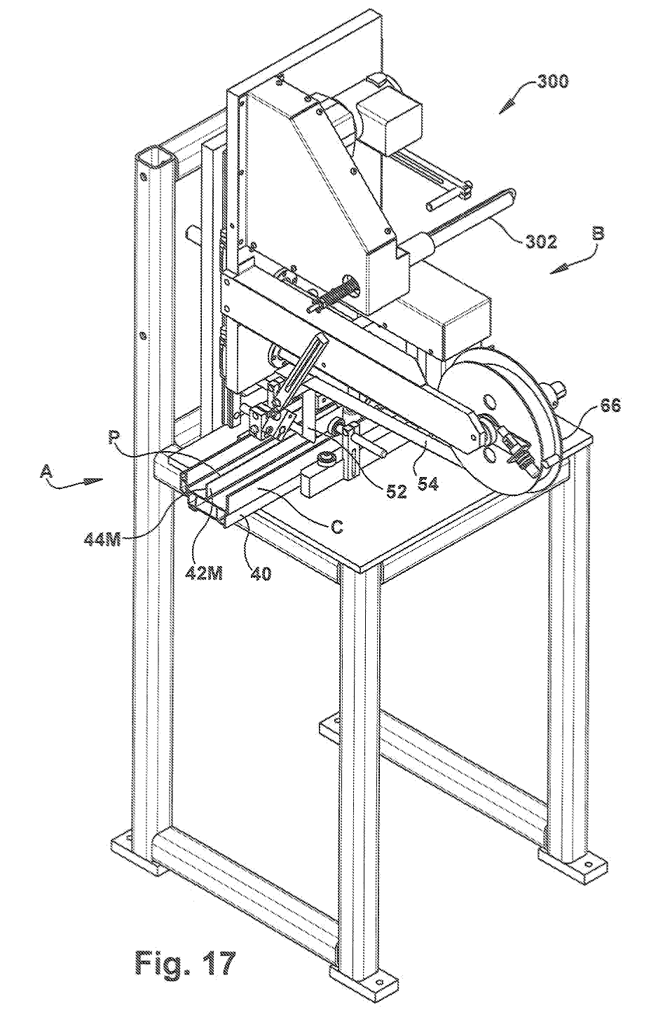

FIG. 17 illustrates a left side perspective view of an applicator assembly 300 constructed in accordance with another example embodiment of the present disclosure. The applicator assembly 300 is shown applying a covering material 52 (as described in FIG. 6 or alternatively manufactured by CPS Resources of Indian Trail, N.C.) to a component C as it passes through an entrance side “A” to an exit side “B” of the applicator. In the illustrated example embodiment, the component C is a vinyl channel assembly 40 having a middle track 42M, 44M, 43M used to support a window sash or door structure, but could include any window component or door supporting track assembly, including but not limited to stiles, rails, tracks, jambs, sills, casings, headers, and channels on both interior and exterior sides without departing from the spirit and scope of the claimed disclosure. The applicator assembly 300 can apply the covering material to any component C without regard to the component's stock length that can be several meters, while only a small portion is shown in the illustrated embodiment of FIG. 17.

The covering material 52 in the example embodiment is applied to the desired portion P of the component through the combination of heat and pressure applied by the applicator assembly 300. The applicator assembly 300 may also be used to apply the decorative covering material 52 to a window sash 10 that may include an insulating glass unit or alternatively a door assembly 11. In FIGS. 4A-4D, the decorative covering material 52 has been adhered automatically by the applicator 300 uniquely to one side of the middle flange 42M, 44M of the channel 40 and 43M of door assembly 11. Such an application was unachievable with conventional equipment. By applying a wood simulated covering material 52 to one side of the middle flange 42M, 44M, and 43M as best seen in FIGS. 4A-4D, when looking from the inside the building or home outward, the covering material on the middle flange blends nicely with the wood or wood appearance on the window sash or door and exposed portions of the window or door frame and trim molding. In contrast, the opposite side of the middle flange as seen from the outside the home or building remains white or a decorative adhesive of a prescribed color is in the covering material 52 similarly applied to the component C such that the exterior and side of the middle flange conveniently match the exterior of the door or window trim.

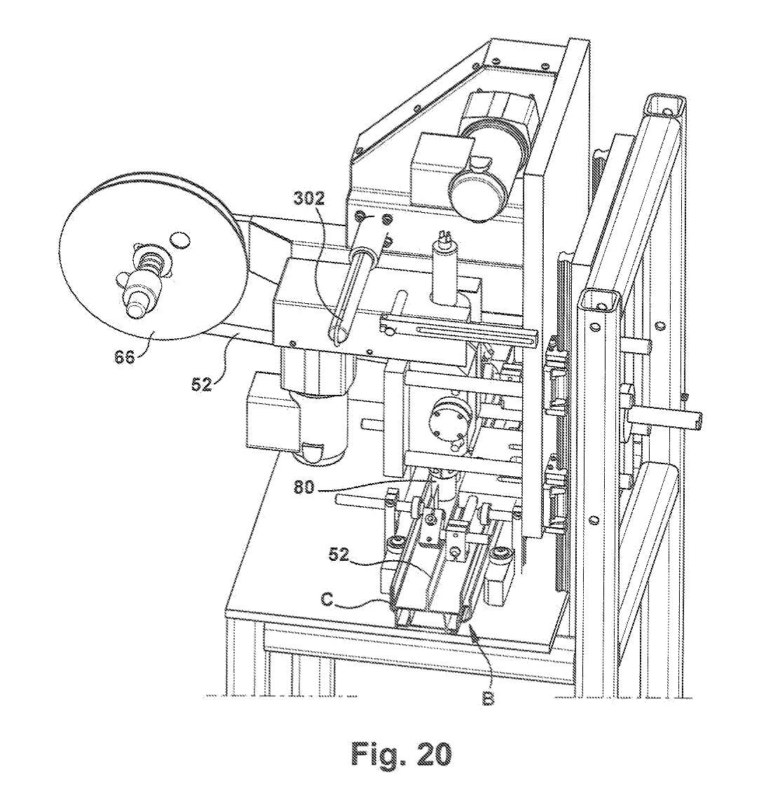

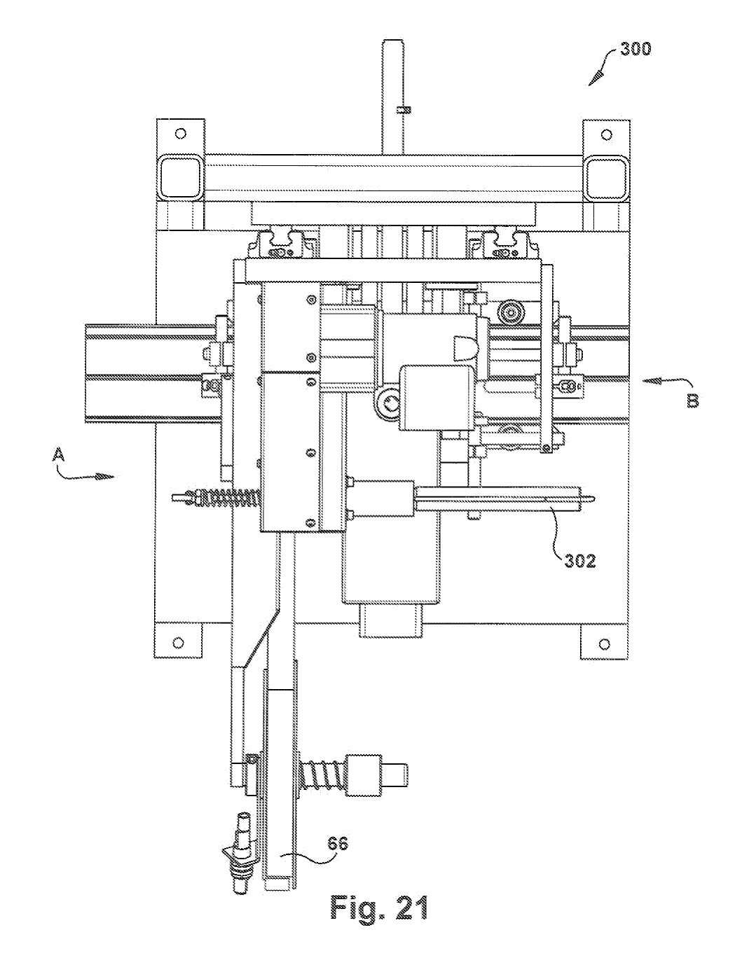

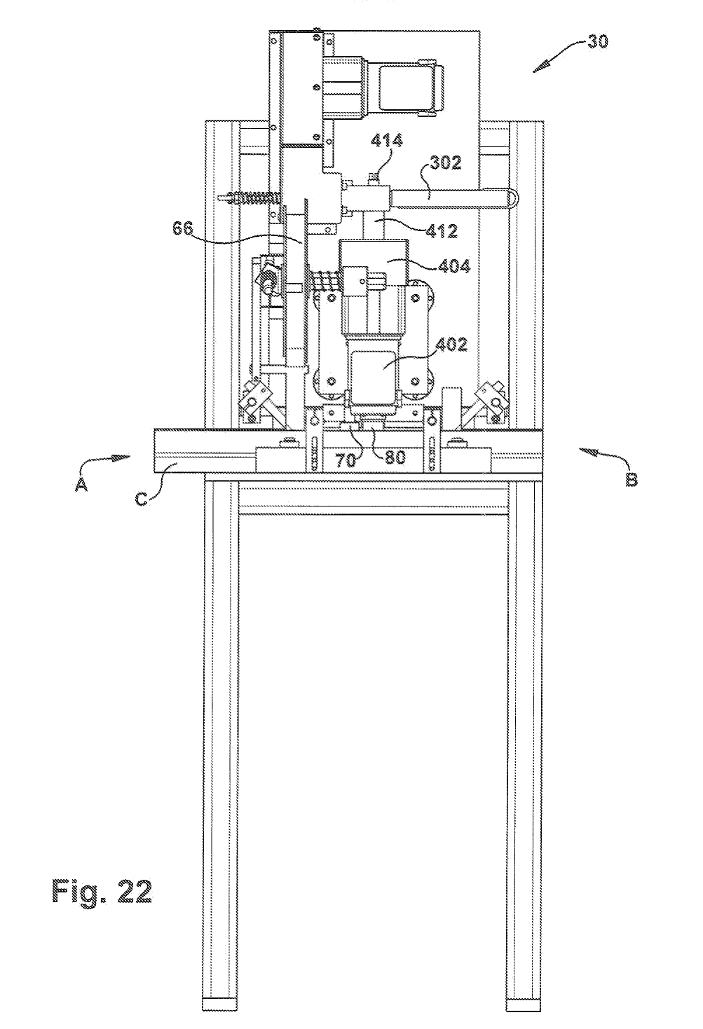

In the illustrated example embodiment of FIGS. 17-25, the applicator assembly 300 is constructed to adjust for strips 54 and components C of varying thicknesses up to several inches without departing from the spirit and scope of this disclosure. The surface of the desired portion P in the illustrated embodiment of FIG. 17 is a vinyl surface, but could equally be a metal, fiberglass, a naturally existing material, or painted surface without departing from the spirit and scope of the claimed disclosure.

Returning again to FIG. 17, the covering material 52 that includes the carrier layer 56 to form the laminating foil 54 is provided to the applicator assembly 300 from a supply reel 66 located transversely from the path of travel of the component C through the applicator assembly. The transverse location makes the changing of the supply reels 66 convenient to the operator of the application assembly 300. The application assembly 300 comprises a support stand 438 formed by a steel tubing frame. During operation, the supply reel 66 remains taunt by a spring assembly 436 that releases the covering material 52 as it passes through the application assembly 300. The carrier layer 56 is collected onto a take-up reel (not shown) by the rotation of the take-up reel shaft 302. The take-up reel shaft 302 is powered by a motor 430 and a gear box 432.

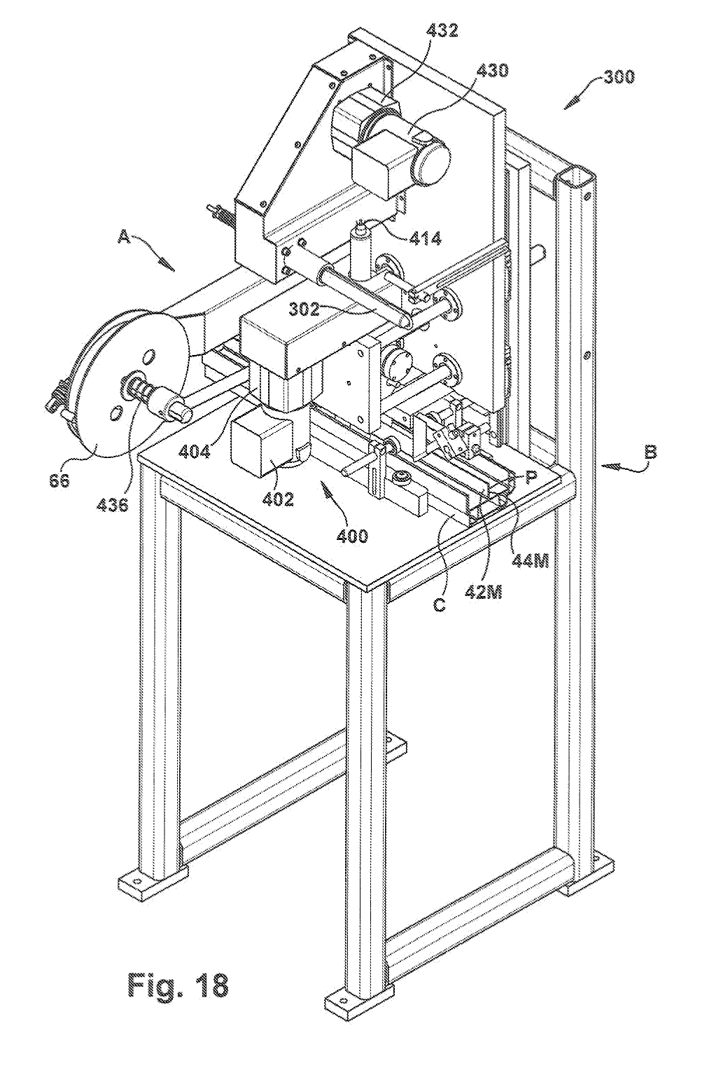

Once the covering material 52 is applied and adhered to the desired portion P of the window or door component C, the carrier layer 56 separates from the laminating foil as a continuous strip as it departs from the exit side B of the applicator 300 as shown in FIG. 17 onto a take-up reel (not shown) supported by a take-up reel shaft 302. In the illustrated example embodiment of FIGS. 17-25, the desired portion P is the interior I and exterior E sides of the middle flange 42M/44M/43M of FIGS. 4A-4D. In particular, FIG. 18 illustrates the covering material 52 being applied to one side of the middle flange 42M.

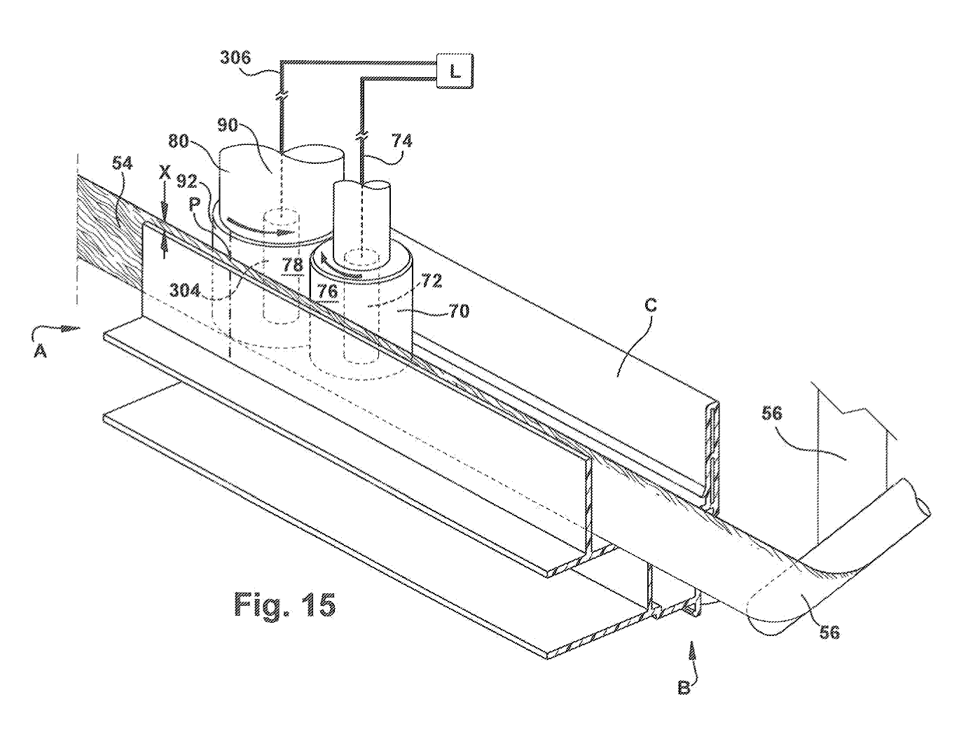

FIG. 15 illustrates magnified exploded perspective view of a portion of the applicator 300 comprising a heat roller 70 having an internal heating element 72. The heating element 72 receives regulated energy from a power source feed 74 attached to a controller L. The controller L can be any computer system, such as a central processing unit, personal computer, programmable logic controller (“PLC”), and the like for monitoring input data and accordingly, adjusting output data as can be appreciated by one skilled in the art.

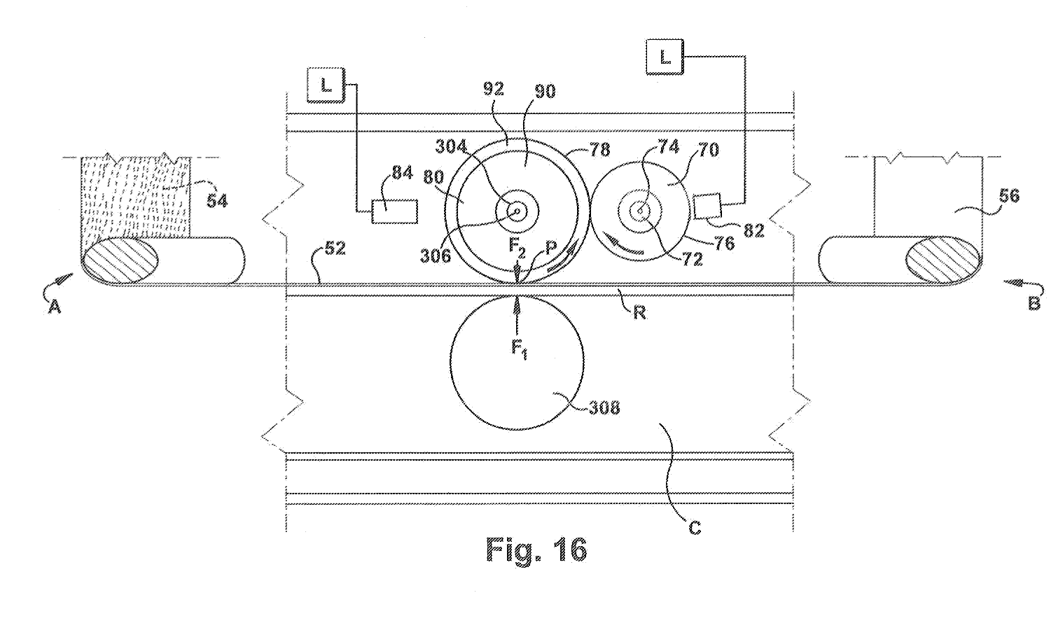

The heating element 72 rotates with the heat roller 70 (as indicated by the arrows in FIGS. 15 and 16) and provides uniform heat throughout the roller, including its external surface 76. The external surface 76 of the heat roller 70 is in physical contact with an external surface 78 of a pressure roller 80. In the illustrated example embodiment of FIGS. 15 and 16, the pressure roller 80 of the applicator assembly 300 further comprises an internal heating element 304. The heating element 304 receives regulated energy from a power source feed 306 also attached to the controller L.

The external surface 78 of the pressure roller 80 through the conductive heat transfer from the heat roller 70 and its contacting surface 76 along with the conductivity of the internal heating element 304 of the pressure roller 80, collectively apply a controlled amount of heat in combination with pressure needed to attach the covering material 52 of the laminating foil 54 to the desired portion P of the component C.

In one example embodiment, the heating elements 72 and 304 are 200 Watt heat sticks, ⅜″ inches in diameter and 1¼″ inches in length. A suitable example of the heating elements 72 and 304 include a heat stick manufactured by Watlow Electric Manufacturing Company of St. Louis, Mo. under part number #G1E95-L2. In the illustrated embodiment, the heating elements 72 and 304 elevate the surface 78 temperature of the pressure roller 80 to a temperature range between 350 and 500 degrees Fahrenheit. In another example embodiment, the pressure roller's 80 outer surface, as measured by heat sensors 84 is regulated by controller L to a temperature of approximately 450 degrees Fahrenheit.

In yet another example embodiment, the heat roller 70 is a constructed from 300 series stainless steel bored for receiving the heating element 72. The heating roller in the illustrated embodiment has a height of approximately two (2″) inches and a diameter of approximately three quarters of one inch (¾″) to fit between the channels of the component C, but could be larger or smaller to accommodate the window or door component C size and area of application.

FIG. 16 illustrates a top view of a magnified portion of the applicator 300. As can be seen in FIG. 16, the heat roller 70 has a smaller diameter than the contacting pressure roller 80. Accordingly, the heat roller 70 does not contact the component C, as the component moves past and through the applicator assembly 300. Heat sensors 82 and 84 measure the surface temperature of the pressure roller 80 and heat roller 70 and communicate the temperatures to the controller “L” in a feedback control signal loop, allowing for the adjustment of the heating elements 72 and 304 to a prescribed temperatures or ranges of temperature. Infrared sensors known by those skilled in the art are suitable examples for the heat sensors 82 and 84. Additional heat sensors (not shown) could be added for monitoring or safety around the perimeter of the heat roller 70 and/or pressure roller 80.

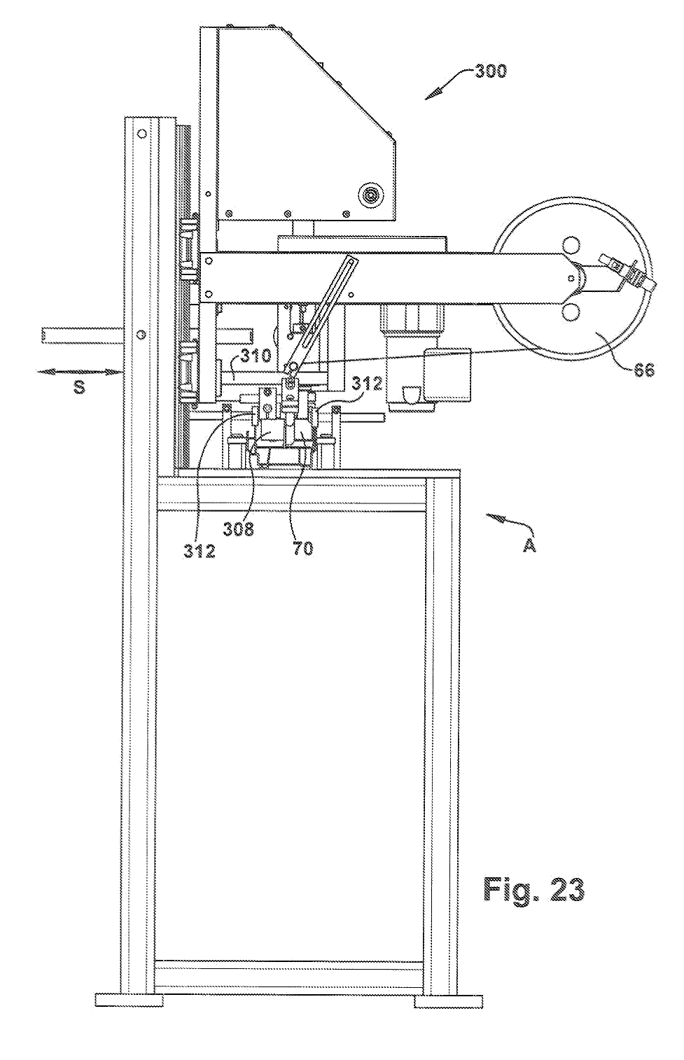

Located opposite a riser portion R of the component C on which the covering material 52 is applied is an idler roller 308. The idler roller 308 applies a reactant force F1 against an applied force F2 generated by the pressure roller 80. The force required and applied by the pressure roller 80 will vary based on the profile of the component C. However, most applications will have a load setting up to approximately 1,800 pounds of force at the surface of the pressure roller 80. In the illustrated embodiment of FIG. 16, the amount of applied force F2 by pressure roller 80 against the laminating foil 54, riser portion R and idler roller 308 at the desired portion P in one example embodiment is one hundred and five (105) pounds force. In the illustrated example embodiment of FIG. 16, the pressure roller 80 contacts 0.12 (in²) square inches of the riser portion R, resulting in eight hundred seventy-five (875) pounds per square inch of pressure PSI. The amount of pressure however can be altered for higher or lower levels through an adjustment slide 310 (see FIG. 23) that increases or decreases the distance (and resulting force) of the idler roller 86 from the pressure roller 80 the directions of the arrow S shown in FIG. 23.

In the example embodiment of FIGS. 15-25, the pressure roller 80 comprises an aluminum hub 90 bored for receiving the heating element 304. The hub 90 is surrounded by a silicone annular outer surface 92 approximately a quarter of one inch in thickness (¼″) that is integral with and molded to the aluminum hub. In the illustrated example embodiment, the silicone outer surface 92 has a relative softness ranging between 50 to 90 on a Shore A scale, a height of two (2″) inches, and a diameter of approximately one (1″) inch to fit between the channels divided by the middle flange 42M, 44M, and 43M of the component C, but could be larger or smaller to accommodate the window or door component size and area of application. Using the heat roller 70 in contact with the silicone outer surface 92 in combination with the internal heating element 304, allows for a controlled amount of heat exposure on the inner diameter of the silicone outer surface, preventing an adhesive used to attach the silicone outer surface along its inner diameter to the aluminum hub 90 from breaking down or delaminating. The silicone outer surface 92 provides a pliable contact surface to the decorative material 52 and the component C. In the illustrated example embodiment of FIGS. 15-25, the outer surface of the pressure roller 80 is maintained at a surface temperature range between 350-500 degrees Fahrenheit, and more specifically, approximately 450 degrees Fahrenheit for the application of the covering material 52 of FIG. 6 (or as manufactured by CPS Resources) as applied by the application assembly 300 onto a vinyl component C.

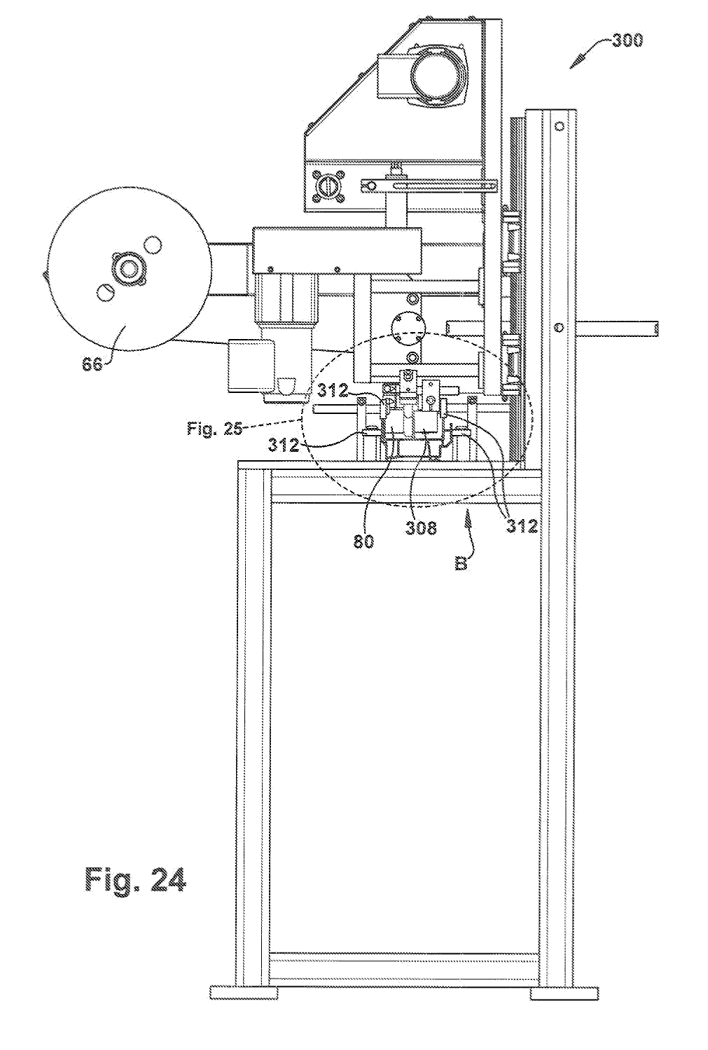

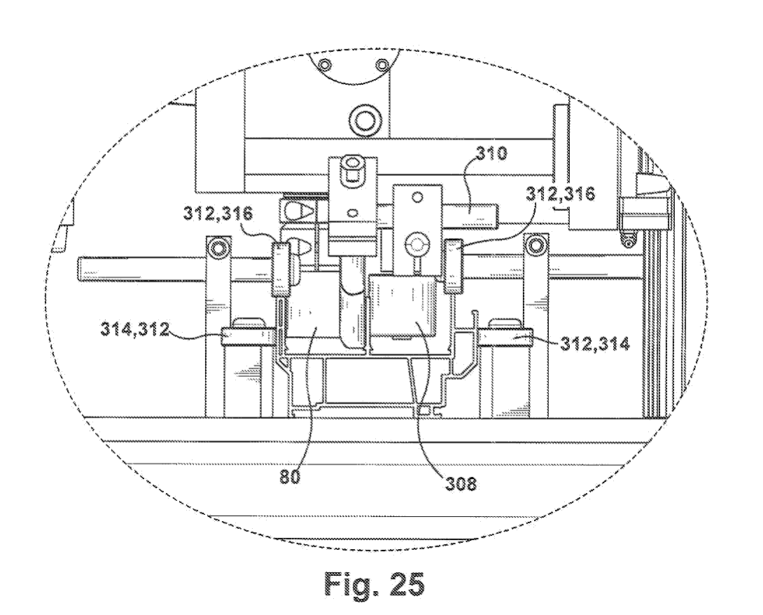

FIGS. 23 and 24 illustrate right and left side perspective and views of the applicator assembly 300 constructed in accordance with one embodiment of the present disclosure. FIG. 25 illustrates ancillary vertical rollers 94 that engage and support the component C as it passes through the applicator assembly 300. Additional support is provided to the component C as it passes through the applicator 300 by horizontal rollers 314 and vertical rollers 316. The vertical rollers 316 and horizontal rollers 314 can be adjusted to accommodate any window or door component C through fixture adjustments as can be appreciated by those skilled in the art without departing from the spirit and scope of the claimed invention.

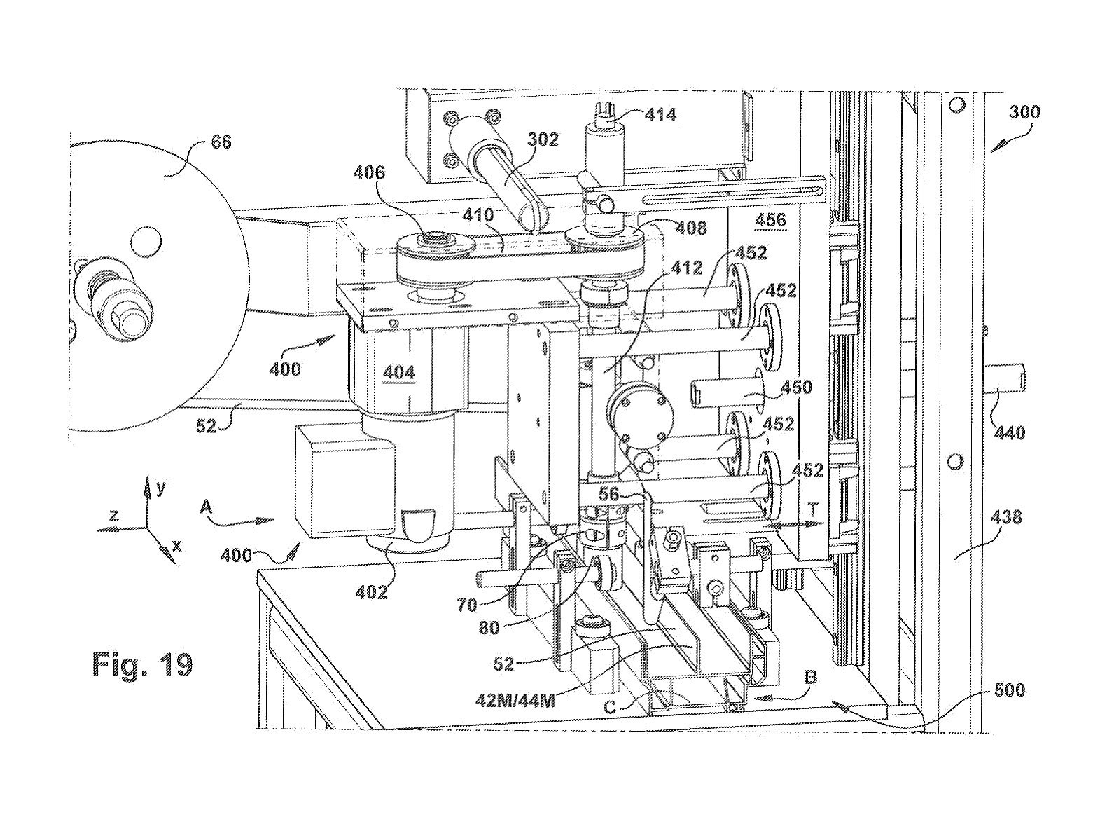

Referring now to FIGS. 18 and 19 are perspective views of the applicator assembly 300 constructed in accordance with one example embodiment of the present disclosure. The pressure roller 80 and heat roller 70 are rotated by a drive assembly 400. The drive assembly 400 comprises a motor 402 engaged to a gear box 404 that includes a pinion gear 406 coupled a drive gear 408 via a drive belt or drive chain 410 attached to a drive shaft 412 as shown in FIG. 19. The pressure roller 80 is coupled to, and rotated by the drive shaft 412. The contact of the pressure roller 80 with the heater roller 70 causes the rotation of the heater roller 70, as indicated by the arrows shown in FIGS. 15 and 16. The pressure roller 80 in addition to providing both heat and pressure to the component C, drives the component through the applicator assembly 300.

The lateral positioning of the heat and pressure rollers 70 and 80, respectively, and drive assembly 400 as indicated by the direction of arrows T in FIG. 19 is achieved through the activation of a motor 440. The motor 440 rotates screw gear 450 that translates the slides 452 and rollers, 70, 80, and drive assembly 400 that are supported by guide members 452 that translate through a fixture block 456.

As can be appreciated by one skilled in the art when reviewing the drawings and in particular FIG. 19, the component C passes through the workstation or applicator assembly 300 through a passageway 500 formed by fixturing constructed of idle rollers vertical and horizontal e.g. 308-312 with adjustments to accommodate an unlimited number of profiles of the components forming the door and window assemblies. In the example embodiment of FIG. 19, the passageway 500 accommodates the particular profile of the component C from the entry side A to the exit side B of the applicator assembly 300 along a first direction indicated by axis “X” of the coordinate system shown. The pressure roller 80 applies heat and pressure to decorative material 52 to the window or door component C along a second direction indicated by axis “Y” of the coordinate system shown. More specifically, the decorative material 52 is applied along the second direction Y which is transverse and substantially orthogonal to the first direction X.

In the illustrated example embodiment of FIG. 19, the decorative material 52 is applied to a middle flange 42M/44M/43M of a component C that extends from the component toward the second direction Y. The assembled component C of FIG. 19 is further illustrated in FIGS. 4A and 4B when constructed to form the IGU 10 or door assembly 11 in FIG. 4D.

Referring again to FIGS. 16 and 19, the pressure roller 80 and heat roller 70 comprise central axes that are parallel along the first direction X. In the example embodiment of FIG. 19, the supply reel 66 provides decorative material 52 to the component C along a third direction indicated by axis “Z” of the coordinate system shown that is transverse to both the first direction X and second direction Y.

In one embodiment, the drive gear 408 is a uni-directional slip drive. The uni-directional slip drive allows a combination of multiple applicator assembly machines 300 to be placed in series for the simultaneous application of covering material 52 to different portions along the channels of the components C. The multiple applicator assemblies 300 in combination with a uni-direction slip drive 408 would allow the applicator machine with the fastest feed rate to control the movement of the component C through the applicator assemblies. This would avoid the need for synchronizing the applicator assemblies' 300 motor speeds. An example of a suitable uni-direction slip drive gear 408 can be purchased from McMaster-Carr website www.mcmaster.com, which is identified as one way locking needle bearing gear under McMaster-Carr part number #2489K5.

As the heater roller 70 and pressure roller 80 rotates, the power source feed 74 and 306 to controller L advantageously remains stationary due to a rotational switch 414 illustrated in FIG. 18. In one embodiment, the rotational switch is a mercury switch capable of handling the 200 W heating elements 72 and 304. An example of a suitable rotational switch 414 includes a switch manufactured by Mercotac, Inc. Carlsbad, Calif. under part number #MER00230.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the spirit and scope of the appended claims.

What is claimed is:

1. An apparatus for applying decorative material to a component, the apparatus comprising:
a workstation defining a passageway for movement of a component along a first direction through said passageway in said workstation;
a first roller having a first outer diameter and a heating element positioned within said first outer diameter; and
a second roller having a second outer diameter in rotational contact with said first outer diameter of said first roller, the first roller providing heat to said second outer diameter of said second roller;
said second roller further for applying heat and pressure along a second direction to a decorative material and a surface of a component, the heat and pressure to be applied by the second roller bonds said decorative material to the surface of the component along said second direction during operation of the apparatus, wherein said second direction is transverse to said first direction.

2. The apparatus of claim 1 wherein said second outer diameter of said second roller is larger than said first outer diameter of said first roller.

3. The apparatus of claim 2 wherein said first and second rollers each have a central axis that are parallel to each other along said first direction.

4. The apparatus of claim 1 wherein said second direction is substantially orthogonal to said first direction during operation of said apparatus.

5. The apparatus of claim 1 wherein said second roller further acts as a drive roller for advancing a component through said passageway along said first direction during operation of said apparatus.

6. The apparatus of claim 1 wherein said second roller further comprises a heating element centrally positioned within said second outer diameter, the heating element within said second outer diameter providing additional heat to said decorative material that is applied to a component during operation of said apparatus.

7. The apparatus of claim 6 wherein said second outer diameter of said second roller applies heat and pressure to decorative material upon the surface of a component along said second direction during operation of said apparatus, and said first roller forming a void between said first outer diameter and said component along said second direction.

8. The apparatus of claim 1 further comprising a supply reel for dispensing decorative material, the supply wheel dispensing decorative material during the operation of said apparatus along a third direction transverse to both said first direction and said second direction.

9. The apparatus of claim 1 wherein said second roller further comprises a drive assembly for moving a component through said passageway along said first direction during operation of said apparatus, the drive assembly comprising a motor and a gear box remotely connected to said second roller through a drive chain and drive shaft coupled to said second roller.

10. The apparatus of claim 9 wherein said first and second rollers and drive assembly are adjustably positioned along a third direction through an adjustment assembly comprising a motor and screw gear passing through a fixture block that translates said first and second rollers and drive assembly to a desired position.

11. The apparatus of claim 10 wherein said desired position is selectably elected from a number of positions programmed in a controller forming part of and in communication with said apparatus.

12. The apparatus of claim 11 further comprising at least one rotational switch in communication with said controller and at least one of said heating elements.

13. An apparatus for applying decorative material to a component comprising:
a first roller comprising a heating element substantially located centrally within the first roller;
a second roller having a central hub surrounded by an outer surface, the outer surface in contact with said first roller, the first roller heating the outer surface of the second roller to a prescribed temperature;
a plurality of idler rollers that during operation of the apparatus are in contact with a component as it is advanced through said apparatus; and
at least one of said idler rollers is located opposite said second roller at an application region with at least a section of a component during operation of the apparatus passing therebetween, the second roller applying heat and pressure to a decorative material at the application region, forming a bonding connection between a decorative material and a component during operation of the apparatus.

14. The apparatus of claim 13 wherein said outer surface attached to said second roller has a durometer ranging between 50 and 90 on a Shore A scale.

15. The apparatus of claim 13 wherein said outer surface attached to said second roller is a silicone surface molded to the perimeter of said second roller.

16. The apparatus of claim 13 additionally comprising a supply for dispensing tape of the decorative material to the application region for heat and pressure bonding of said decorative material to a component.

17. A method for applying decorative material using an application station to a component comprising the steps of:
fixing a heat roller and a pressure roller in rotational contact at a decorative application station;
heating the surface of the pressure roller due to contact with the heat roller;
driving a component through the decorative application station along a first direction with the rotational movement of the pressure roller;
moving a decorative material through the decorative application station simultaneously with a component; and
applying heat and pressure to the component and a decorative material with the pressure roller to form an adhesive bond between at least a portion of the decorative material and component.

18. The method of claim 17 further comprising heating the surface of said pressure roller by positioning a heating element within said pressure roller.

19. The method of claim 17 wherein said step of forming an adhesive bond between said decorative material and a component occurs on a surface of the component at a second direction substantially orthogonal to said first direction.

20. The method of claim 19 wherein said step of forming an adhesive bond between said decorative material and a component occurs on a middle flange forming two channels of the component that extends transversely from said first direction.

21. The apparatus of claim 1 wherein said decorative material applied to a component is applied to a middle flange forming two channels of the component that extends transversely from said first direction.
